(19) United States
(12) Patent Application Publication
(10) Pub. No.: US 2014/0002448 A1
(43) Pub. Date: Jan. 2, 2014

(54) MEASUREMENT SUPPORT DEVICE, METHOD AND COMPUTER PROGRAM PRODUCT

(71) Applicant: KABUSHIKI KAISHA TOSHIBA, Tokyo (JP)

(72) Inventors: Satoshi ITO, Kanagawa (JP); Akihito SEKI, Kanagawa (JP); Yuta ITOH, Kanagawa (JP); Masaki YAMAZAKI, Tokyo (JP); Kenichi SHIMOYAMA, Tokyo (JP)

(21) Appl. No.: 13/799,473

(22) Filed: Mar. 13, 2013

(30) Foreign Application Priority Data
Jun. 28, 2012 (JP) 2012-145885

(51) Int. Cl. G06T 15/00

(52) U.S. Cl. CPC G06T 15/00
USPC 345/419

(57) ABSTRACT

According to an embodiment, a measurement support device includes a first calculator configured to calculate, when three-dimensional shape data representing a measured part of an object are viewed from a plurality of points of view, a plurality of first information quantities representing visibility of the three-dimensional shape; a second calculator configured to calculate a second information quantity by multiplying a maximum value of the first information quantities by a predetermined proportion; a selector configured to select a point of view, which has a smaller difference between the first information quantity and the second information quantity, from the points of view; and a display controller configured to display the three-dimensional shape data as viewed from the selected point of view on a display unit.

### CROSS-REFERENCE TO RELATED APPLICATIONS

This application is based upon and claims the benefit of priority from Japanese Patent Application No. 2012-145885, filed on Jun. 28, 2012; the entire contents of which are incorporated herein by reference.

### FIELD

Embodiments described herein relate generally to a measurement support device, a method therefor and a computer program product.

### BACKGROUND

In three-dimensional measurement of an object, a measurer needs to check the status of the measurement of the object to determine a part for which the measurement is not sufficient and decide on the next part to be measured. In order to facilitate the measurement status check, a technique for displaying an image of three-dimensional shape data representing measured parts of an object as viewed in an arbitrary direction is known.

With such a known technique as described above, a user specifies the position of the point of view from which the three-dimensional shape data representing measured parts of an object are viewed, in which there is room for improvement for increasing the efficiency of the measurement work.

### BRIEF DESCRIPTION OF THE DRAWINGS

FIG. 1 is a diagram illustrating an example of a measurement support device according to a first embodiment;

FIG. 2 is a diagram illustrating an example of a set of points of view according to the first embodiment;

FIG. 3 is a diagram illustrating an example of first information quantities according to the first embodiment;

FIG. 4 is a graph illustrating an example of selecting points of view P4 and P6 according to the first embodiment;

FIG. 5 is a flowchart illustrating an example of a measurement support process according to the first embodiment;

FIG. 6 is a diagram illustrating an example of a measurement support device according to a second embodiment;

FIG. 7 is a flowchart illustrating an example of a generation process according to the second embodiment;

FIG. 8 is a diagram illustrating an example of a set of points of view to be selected according to a modified example 1;

FIG. 9 is a diagram illustrating an example of partial first information quantities according to the modified example 1;

FIG. 10 is a diagram illustrating an example of a first information quantity for each combination of points of view according to the modified example 1; and

FIG. 11 is a diagram illustrating an example of a first information quantity according to a modified example 3.

### DETAILED DESCRIPTION

According to an embodiment, a measurement support device includes a first calculator configured to calculate, when three-dimensional shape data representing a measured part of an object are viewed from a plurality of points of view, a plurality of first information quantities representing visibility of the three-dimensional shape; a second calculator configured to calculate a second information quantity by multiplying a maximum value of the first information quantities by a predetermined proportion; a selector configured to select a point of view, which has a smaller difference between the first information quantity and the second information quantity, from the points of view; and a display controller configured to display the three-dimensional shape data as viewed from the selected point of view on a display unit.

Embodiments will be described in detail below with reference to the accompanying drawings.

### First Embodiment

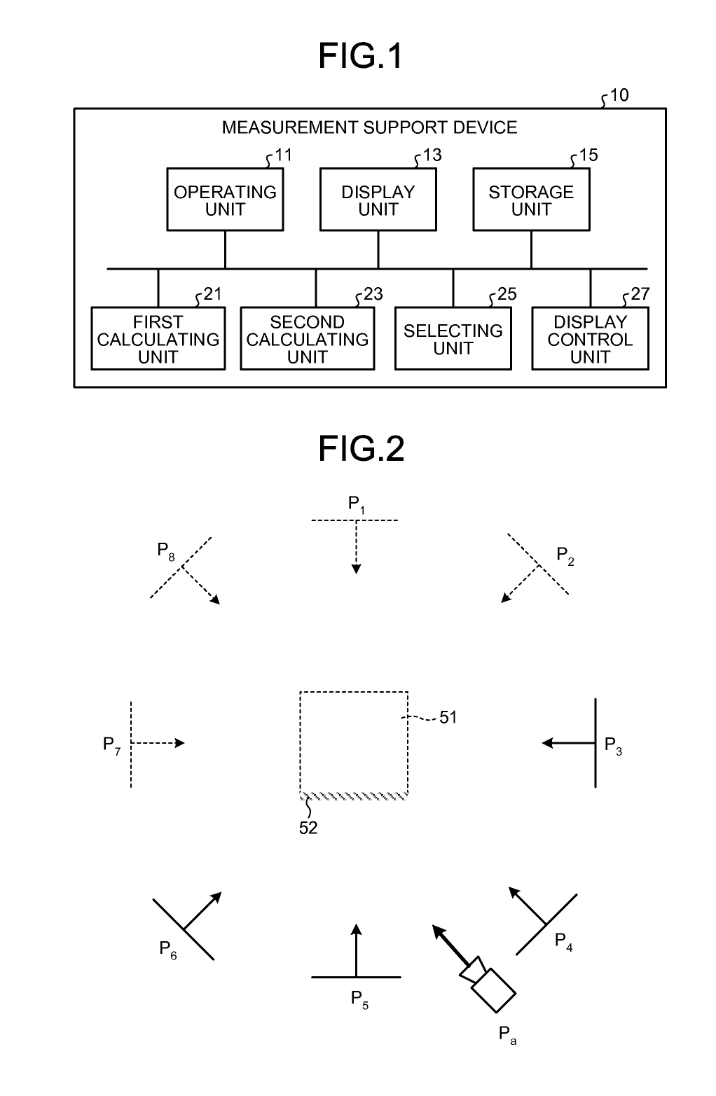

FIG. 1 is a configuration diagram illustrating an example of a measurement support device 10 according to a first embodiment. As illustrated in FIG. 1, the measurement support device 10 includes an operating unit 11, a display unit 13, a storage unit 15, a first calculating unit 21, a second calculating unit 23, a selecting unit 25, and a display control unit 27.

The operating unit 11 performs various operation inputs and can be implemented by an input device such as a keyboard, a mouse, a touch pad and a touch panel.

The display unit 13 displays various screens and can be implemented by a display device such as a liquid crystal display and a touch screen display.

The storage unit 15 stores therein various programs executed in the measurement support device 10, data used for various types of processing performed by the measurement support device 10, and the like. The storage unit 15 can be implemented by a storage device that is magnetically, optically or electrically recordable such as a hard disk drive (HDD), a solid state drive (SSD), a memory card, an optical disc, a read only memory (ROM), and a random access memory (RAM).

The storage unit 15 stores therein three-dimensional shape data representing measured parts of an object to be measured existing in the real world. The three-dimensional shape data is a result of three-dimensional measurement of a measured part of an object to be measured and is data representing the shape of the measured part of the object.

In the first embodiment, the three-dimensional shape data is a set of points constituting the shape of a measured part of an object to be measured, that is, point cloud data. Points belonging to three-dimensional shape data (point cloud data) each have coordinates representing a position in a three-dimensional space. Any three-dimensional system can be used for the coordinate system that is a reference for the coordinates.

The three-dimensional shape data, however, is not limited to point cloud data but may be mesh data representing the shape of a measured part of an object to be measured as a mesh, polygon data, or the like, for example.

Moreover, the three-dimensional shape data may include a normal vector of a surface of a measured part of an object to be measured and texture information of the object to be measured in addition to the data, such as point cloud data, representing the shape of the measured part of the object to be measured.

The storage unit 15 also stores therein a history of points of view previously selected by the selecting unit 25 that will be described later.

The first calculating unit 21, the second calculating unit 23, the selecting unit 25 and the display control unit 27 can be implemented by causing a processing device such as a central processing unit (CPU) execute programs, that is by software.

The first calculating unit 21 calculates a plurality of first information quantities representing the visibilities of the three-dimensional shape when the three-dimensional shape data of an object are viewed from a plurality of points of view. In the first embodiment, the first calculating unit 21 acquires three-dimensional shape data of an object to be measured from the storage unit 15, and calculates a first information quantity when the three-dimensional shape data is viewed from each of a plurality of points of view.

The points of view are part of a set of points of view provided as points of view from which the three-dimensional shape data is viewed. Specifically, the points of view are a set of points of view to be selected by the selecting unit 25 that will be described later in the set of points of view provided in advance as points of view from which the three-dimensional shape data is viewed. The set of points of view to be selected is a set of all the points of view that are specified in the set of points of view provided in advance as points of view from which the three-dimensional shape data is viewed, and may be a set of points of view within a certain distance from specified coordinates or may be a set of points of view at a certain distance or farther from specified coordinates, for example. The specified coordinates may be those of a previous point of view selected by the selecting unit 25 that will be described later. Note that the set of points of view to be selected may be a set of points of view in a three-dimensional space or may be a set of points of view in any two-dimensional space.

FIG. 2 is an explanatory diagram illustrating an example of the set of points of view according to the first embodiment. In the example illustrated in FIG. 2, points of views P₁ to P₈ and a point of view Pₐ are provided in advance as the set of points of view from which three-dimensional shape data 52 of an object 51 to be measured are viewed. The previous point of view is Pₐ, and the set of points of view to be selected includes the points of view P₃ to P₆ that are within a certain distance from the previous point of view Pₐ. In the example illustrated in FIG. 2, the first calculating unit 21 calculates the first information quantity when the three-dimensional shape data 52 are viewed from each of the points of view P₃ to P₆. Note that the object 51 is illustrated only for convenience of explanation, but does not actually exist in the virtual space illustrated in FIG. 2.

The first information quantity may be any information that represents the visibility of a three-dimensional shape viewed from a point of view. In the first embodiment, it is assumed that the first information quantity is a projected area of the three-dimensional shape data projected on a projection plane in the line-of-sight direction or the direction opposite thereto. The first calculating unit 21 can employ various projection methods such as perspective projection and parallel projection for the projection of the three-dimensional shape data.

Note that, when the three-dimensional shape data is mesh data, polygon data or the like, the first calculating unit 21 can simply calculate the projected area because the three-dimensional shape data constructs of a plurality of facets. When the three-dimensional shape data is point cloud data, however, the first calculating unit 21 cannot simply calculate the projected area because the three-dimensional shape data does not constructs of facets. Thus, the first calculating unit 21 calculates the projected area by approximating the point data as a microsphere or a microcube. Alternatively, the first calculating unit 21 may calculate the projected area by forming facets by assigning a mesh to the point cloud data.

In calculation of the first information quantity, the first calculating unit 21 needs not use all the point data constituting the three-dimensional shape data but only needs to use a part thereof. For example, the first calculating unit 21 may calculate the first information quantity by using point data with coordinate values within a specified range among all the point data. The specified range can be a certain distance or shorter from the previous point of view selected by the selecting unit 25 that will be described later, for example.

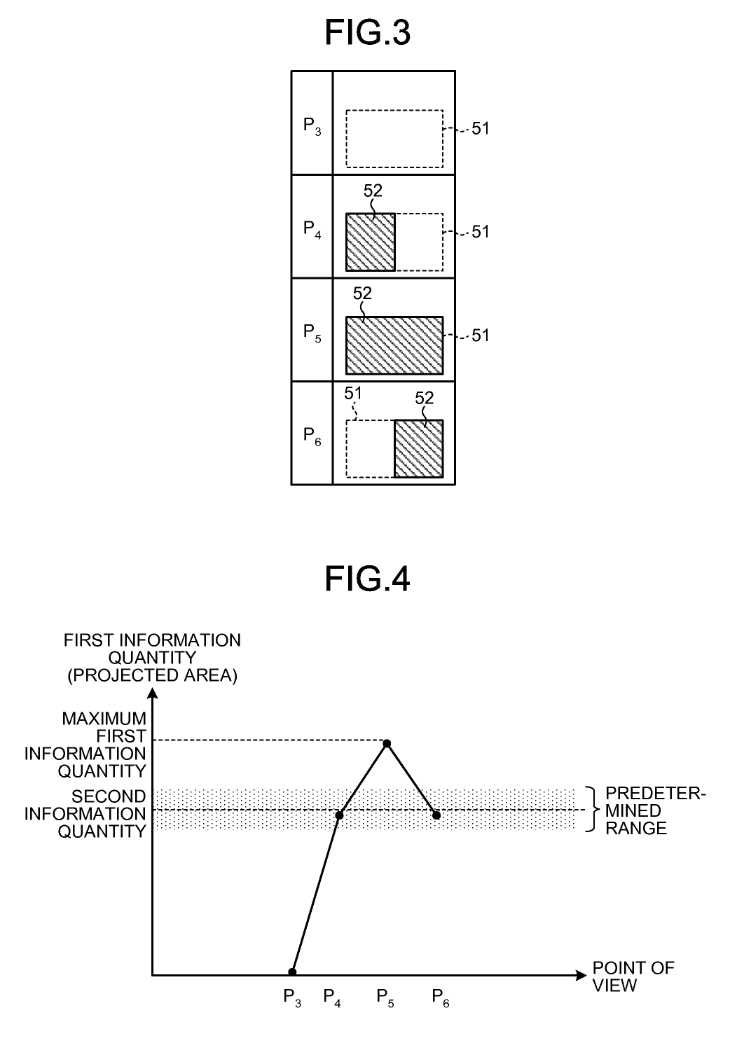

FIG. 3 is an explanatory diagram illustrating an example of the first information quantities according to the first embodiment, and illustrates the first information quantities (projected areas) of the points of view P₃ to P₆ to be selected in the example illustrated in FIG. 2. The example illustrated in FIG. 3 presents projections of the three-dimensional shape data 52 of the object 51 to be measured at the respective points of view P₃ to P₆, and hatched parts represent the three-dimensional shape data 52. Note that the object 51 is illustrated only for convenience of explanation, but does not actually exist. In the example illustrated in FIG. 3, the first information quantity of P₅ is the greatest, the first information quantities of P₄ and P₆ are substantially equal, and the first information quantity of P₃ is the smallest.

The second calculating unit 23 calculates a second information quantity by multiplying a maximum first information quantity that is the maximum value of a plurality of information quantities calculated by the first calculating unit 21 by a predetermined proportion.

The second calculating unit 23 calculates the maximum first information quantity by using an expression (1), for example.

$${V}_{max} = {max}_{P ∈ S} V ( P ) \qquad ( 1 )$$

In the expression, Vₘₐₓ represents the maximum first information quantity, and satisfies Vₘₐₓ=V(Pₘₐₓ). Pₘₐₓ represents the point of view with the maximum first information quantity, and V(Pₘₐₓ) represents the first information quantity of the point of view Pₘₐₓ. Specifically, in the expression (1), the maximum first information quantity is determined among the first information quantities of the respective points of view P to be selected that constitute the set S. Note that Pₘₐₓ is not limited to a single point of view but there may be a plurality of Pₘₐₓ.

The second calculating unit 23 also calculates the second information quantity by using an expression (2), for example.

V_{c}=r×Vₘₐₓ (2)

In the expression, V_{c} represents the second information quantity. r is a real constant in a range of 0<r<1. Specifically, in the expression (2), the second information quantity that has a value of (100×r)% of the maximum first information quantity.

The selecting unit 25 selects a point of view from a plurality of points of view by using a difference between each of a plurality of first information quantities calculated by the first calculating unit 21 and the second information quantity calculated by the second calculating unit 23. In the first embodiment, the selecting unit 25 selects a point of view with the first information quantity whose difference from the second information quantity calculated by the second calculating unit 23 is within a predetermined range among a plurality of first information quantities calculated by the first calculating unit 21. The selecting unit 25 then stores information, such as coordinate information and an identifier of the selected point of view with which the selected point of view can be identified, in the storage unit 15 as a history.

Note that the point of view that is selected by the selecting unit 25 is a point of view with the first information quantity whose difference from the second information quantity is within a predetermined range because a point of view with the second information quantity does not always exist in the set of point of views to be selected (point of views with the first information quantities).

The selecting unit 25 selects a point of view that satisfies an expression (3) among the points of views to be selected, for example.

|V(Pₒᵤₜ)−V_{c}|≦s (3)

In the expression, Pₒᵤₜ represents a point of view selected by the selecting unit 25. s is a predetermined positive real number and represents the predetermined range. Specifically, in the expression (3), a point of view with the first information quantity whose absolute value of the difference from the second information quantity is equal to or less than s. Note that if there is no point of view that satisfies the expression (3) in the points of view to be selected, the selecting unit 25 may select a point of view with the first information quantity whose difference from the second information quantity is the smallest from the points of view to be selected.

FIG. 4 is an explanatory diagram illustrating an example of selection of a point of view according to the first embodiment, and illustrates an example in which the point of view is selected from the points of view P₃ to P₆ to be selected in the example illustrated in FIG. 2. In the example illustrated in FIG. 4, since the difference between the first information quantity of the point of view P₄ and the second information quantity and the difference between the first information quantity of the point of view P₆ and the second information quantity are within the predetermined range, the selecting unit 25 selects the points of view P₄ and P₆. The selecting unit 25 may select one of the points of view P₄ and P₆ with the first information quantity whose difference from the second information quantity is smaller.

The display control unit 27 displays the three-dimensional shape data as viewed from the point of view selected by the selecting unit 25 on the display unit 13. Specifically, the display control unit 27 acquires the three-dimensional shape data from the storage unit 15 and displays the three-dimensional shape data as viewed from the point of view selected by the selecting unit 25 on the display unit 13.

The display control unit 27 can use various display techniques. For example, the display control unit 27 may display the three-dimensional shape data like computer aided design (CAD) software, or may display the three-dimensional shape data by using a technology disclosed in Japanese Patent Application Laid-open No. 2002-352271.

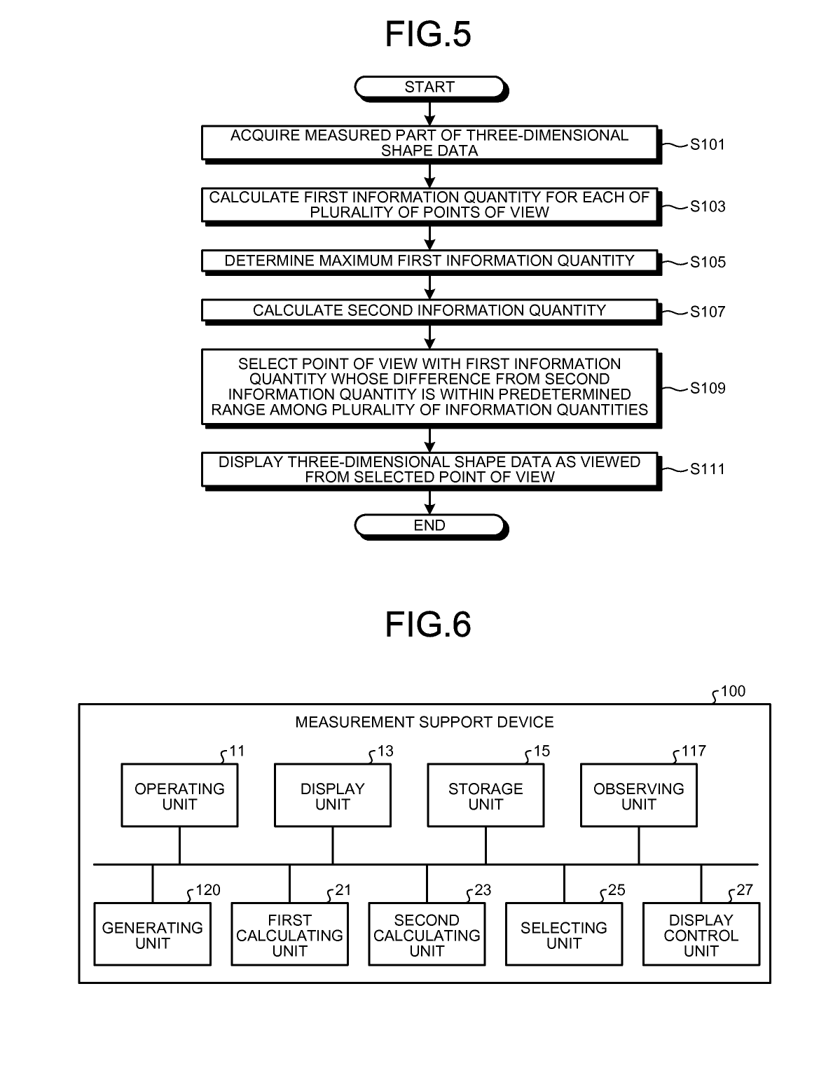

FIG. 5 is a flowchart illustrating an example of a flow of procedures of a measurement support process performed by the measurement support device 10 according to the first embodiment.

First, the first calculating unit 21 acquires three-dimensional shape data of an object to be measured (measured part of the object to be measured) from the storage unit 15 (step S101).

Subsequently, the first calculating unit 21 calculates a first information quantity representing the visibility of the three-dimensional shape image as viewed from each of a plurality of points of view (step S103).

Subsequently, the second calculating unit 23 determines a maximum first information quantity that is the maximum value among the first information quantities calculated by the first calculating unit 21 (step S105).

Subsequently, the second calculating unit 23 calculates a second information quantity by multiplying the determined maximum first information quantity by a predetermined proportion (step S107).

Subsequently, the selecting unit 25 selects a point of view with the first information quantity whose difference from the second information quantity calculated by the second calculating unit 23 is within a predetermined range among the first information quantities calculated by the first calculating unit 21 (step S109).

Subsequently, the display control unit 27 displays the three-dimensional shape data as viewed from the point of view selected by the selecting unit 25 on the display unit 13 (step S111).

Afterwards, the user (measurer) determines a point of view in the real space (real world) from which next observation is to be made on the basis of the three-dimensional shape data displayed on the display unit 13, observes and measures the object to be measured from the point of view in the real space (real world), and the three-dimensional shape data stored in the storage unit 15 is updated, which will be described in detail in a second embodiment. Then, when the user performs a display operation input for displaying the three-dimensional shape data from a new point of view through the operating unit 11, the process illustrated in FIG. 5 is performed again and the three-dimensional shape data as viewed from the new point of view are displayed on the display unit 13.

As described above, in the first embodiment, the second information quantity is calculated by multiplying the maximum first information quantity that is the maximum value of a plurality of first information quantities by the predetermined proportion, and the three-dimensional shape data as viewed from the point of view with the first information quantity whose difference from the second information quantity is within the predetermined range are displayed.

Note that the point of view with the maximum first information quantity is a point of view from which the three-dimensional shape data, that is, the measured part of the object to be measured can be most efficiently figured out, but is not a point of view from which an unmeasured part of the object to be measured can be efficiently figured out. In contrast, the point of view with the first information quantity whose difference from the second information quantity is within the predetermined range is a point of view from which both the measured part and the unmeasured part of the object to be measured can be efficiently figured out since the second information quantity is a value obtained by multiplying the maximum first information quantity by the predetermined proportion.

According to the first embodiment, it is therefore possible to automatically select a point of view from which the user (measurer) can easily figure out the measurement status of an object to be measured and display three-dimensional shape data therefrom, which can increase the efficiency of the measurement work on the object to be measured.

### Second Embodiment

In the second embodiment, an example of generating (updating) the three-dimensional shape data will be described. In the following, differences from the first embodiment will be mainly described, and components having the same functions as those in the first embodiment will be designated by the same names and reference numerals as in the first embodiment and description thereof will not be repeated.

FIG. 6 is a configuration diagram illustrating an example of measurement support device 100 according to the second embodiment. As illustrated in FIG. 6, the measurement support device 100 according to the second embodiment differs from the measurement support device 10 of the first embodiment in that an observing unit 117 and a generating unit 120 are further provided therein.

The observing unit 117 observes an object to be measured for three-dimensional measurement of the object, and can be implemented by various devices such as a visible light camera, a laser scanner, a laser range sensor, and a camera with a projector that are typically used for three-dimensional measurement. Specifically, the observing unit 117 observes an object to be measured from a point of view in the real space determined by the user (measurer) as a point of view from which the next observation is to be made on the basis of three-dimensional shape data displayed on the display unit 13. In the observation of an object to be measured, the observing unit 117 may observe the object from a single point of view or from a plurality of points of view.

The generating unit 120 generates three-dimensional shape data by using a result of observation (observation data) from the observing unit 117, and stores the generated data in the storage unit 15. When three-dimensional shape data are already stored in the storage unit 15, the generating unit 120 updates the three-dimensional shape data stored in the storage unit 15 with the generated three-dimensional shape data. Since the technique for generating the three-dimensional shape data is known, description thereof will not be provided herein.

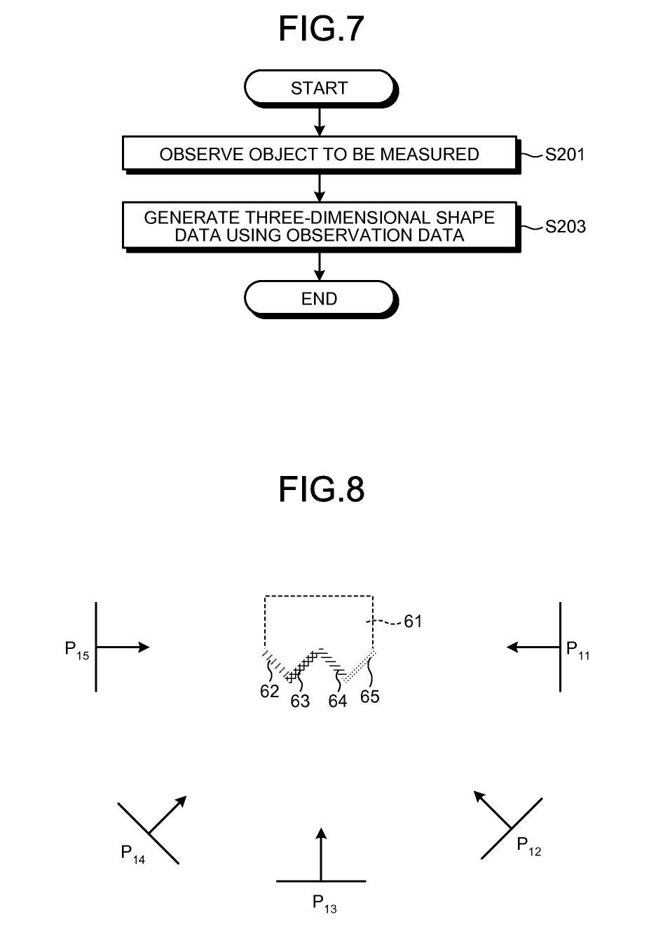

FIG. 7 is a flowchart illustrating an example of a flow of procedures of a generating process performed by the measurement support device 100 according to the second embodiment. In the second embodiment, the measurement support process described in the first embodiment is performed by using three-dimensional shape data generated by this generation process, and subsequently, the generation process and the measurement support process are repeated in this order.

First, the observing unit 117 observes an object to be measured and obtains observation data (step S201). Note that, in the initial observation, the observing unit 117 performs observation from an arbitrary point of view in the real space since there are no three-dimensional shape data to be displayed on the display unit 13, and in the second and subsequent observations, the observing unit 117 performs observation from a point of view in the real space from which the user (measurer) determines to perform the next observation on the basis of three-dimensional shape data displayed on the display unit 13.

Subsequently, the generating unit 120 generates three-dimensional shape data by using observation data from the observing unit 117 and stores the generated data in the storage unit 15 (step S203).

According to the second embodiment, similarly to the first embodiment, it is therefore possible to automatically select a point of view from which the user can easily figure out the measurement status of an object to be measured and display three-dimensional shape data therefrom, which can increase the efficiency of the measurement work on the object to be measured.

### MODIFIED EXAMPLE 1

While examples in which a point of view is selected are described in the embodiments above, a combination of points of view may be selected.

In this case, the first calculating unit 21 calculates a first information quantity for each combination of points of view by summing up the visibilities of parts constituting the three-dimensional shape data.

Specifically, when the set S of points of view to be selected is {P₁, . . . , P_{N}} (N>1), the first calculating unit 21 calculates a first information quantity for each combination of points of view constituted by M (1<M≦N) points of view selected from the points of view to be selected {P₁, . . . , P_{N}}. In the following description, a combination of points of view will be referred to as {P′₁, . . . , P′_{M}} for convenience of explanation.

It is assumed here that the three-dimensional shape data is constituted by Q (Q>1) parts (shape). In this case, the first calculating unit 21 calculates a partial first information quantity vⱼ(P′ᵢ) (j=1, . . . , Q) representing the visibility of each part constituting the three-dimensional shape data for each of the points of view P′ᵢ (i=1, . . . , M) constituting the combination of points of view {P′₁, . . . , P′_{M}}. Since the technique for calculating a partial first information quantity is the same as that for calculating the first information quantity in the first embodiment, the description thereof will not be repeated here. The first calculating unit 21 then obtains a maximum value of the calculated partial first information quantities vⱼ(P′ᵢ) for each part of the three-dimensional shape data, and calculates the first information quantity by summing up the obtained maximum values.

The first calculating unit 21 calculates the first information quantity by using an expression (4), for example.

$$V ( {P}_{1}^{′} , … , {P}_{M}^{′} ) = {\sum }_{j = 1}^{Q} {max}_{i = 1 , … , M} {v}_{j} ( {P}_{i}^{′} ) \qquad ( 4 )$$

In the expression, V(P′₁, . . . , P′_{M}) represents the first information quantity of the combination of points of view {P′₁, . . . , P′_{M}}.

The method for calculating the first information quantity according to the modified example 1 will be described below in detail with reference to FIGS. 8 to 10. An example in which a first information quantity is calculated for each pair of points of view (combination of two points of view) will be described.

FIG. 8 is an explanatory diagram illustrating an example of a set of points of view to be selected according to the modified example 1. In the example of FIG. 8, three-dimensional shape data pieces 62 to 65 of an object 61 to be measured are constituted by four parts, and the set of points of view to be selected consists of points of view P₁₁ to P₁₅.

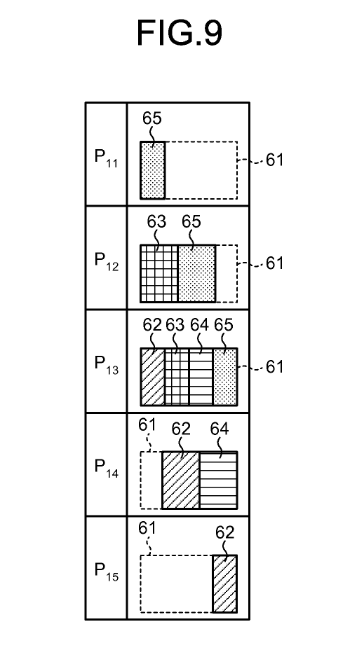

FIG. 9 is an explanatory diagram illustrating an example of partial first information quantities of the respective points of view to be selected according to the modified example 1, and illustrates partial first information quantities (projected areas) of the respective points of view to be selected P₁₁ to P₁₅ in the example of FIG. 8. The example illustrated in FIG. 9 presents projections of the three-dimensional shape data pieces 62 to 65 of the object 61 to be measured at the respective points of view P₁₁ to P₁₅, and hatched parts represent the three-dimensional shape data pieces 62 to 65. In the example illustrated in FIG. 9, the partial first information quantity of the three-dimensional shape data 62 is a maximum value at the point of view P₁₄, the partial first information quantity of the three-dimensional shape data 63 is a maximum value at the point of view P₁₂, the partial first information quantity of the three-dimensional shape data 64 is a maximum value at the point of view P₁₄, and the partial first information quantity of the three-dimensional shape data 65 is a maximum value at the point of view P₁₂.

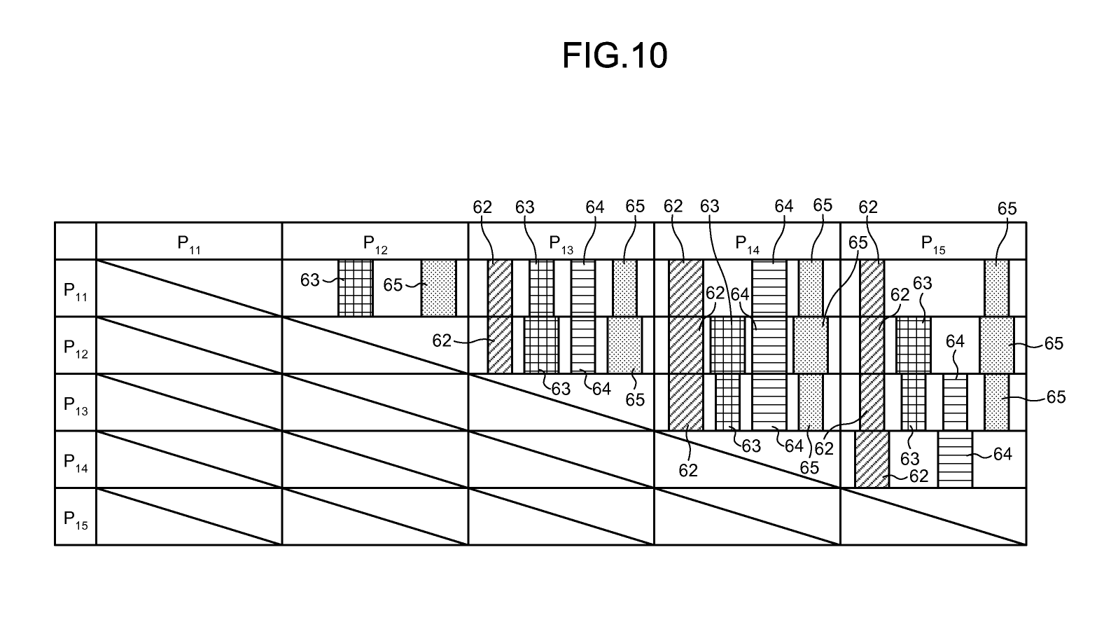

FIG. 10 is an explanatory diagram illustrating an example of the first information quantity of each combination of points of view according to the modified example 1, and presents a sum of the partial first information quantities of each pair of the points of view to be selected P₁₁ to P₁₅ (specifically, a sum of the maximum values of the partial first information quantities for each of the parts of the three-dimensional shape data pieces 62 to 65 in the example illustrated in FIG. 8. In the example illustrated in FIG. 10, a maximum value of partial first information quantities of the respective points of view constituting each pair of points of view for each of the parts of the three-dimensional shape data pieces 62 to 65 is employed and uses a sum of the maximum values as the first information quantity. In the example illustrated in FIG. 10, since the first information quantity of the pair of points of view ₁₂ and P₁₄ is maximum, the second calculating unit 23 determines the first information quantities employed for the pair of points of view P₁₂ and P₁₄ as the maximum first information quantities.

The selecting unit 25 selects a combination of points of view from a plurality of points of view by using the difference between each of the first information quantities calculated by the first calculating unit 21 and the second information quantity calculated by the second calculating unit 23.

The display control unit 27 displays the three-dimensional shape data as viewed from the combination of points of view selected by the selecting unit 25 on the display unit 13.

According to the modified example 1, even in a case where a combination of points of view is selected, it is possible to automatically select a combination of points of view from which the user can easily figure out the measurement status of an object to be measured and display three-dimensional shape data therefrom, which can increase the efficiency of the measurement work on the object to be measured.

### MODIFIED EXAMPLE 2

In the embodiments and the modified example 1 described above, points of view may be selected further taking the relation with a previously selected point of view into account.

In the first embodiment described above, when the relation with a previously selected point of view is taken into account and a point of view in an unobserved direction is to be selected first, the selecting unit 25 may select a point of view by using expressions (5) and (6), for example.

$${D}_{min} = {min}_{t = 1 , … , T} ‖ P - {P}_{t} ‖ \qquad ( 5 )$$

In the expression, Pₜ represents a point of view from which observation is previously performed and satisfies t=1, . . . , T (T≧1). Dₘᵢₙ represents a smallest value of the distances between points of view P to be selected and the point of view Pₜ from which observation is previously performed. Specifically, in the expression (5), the smallest value of the distances between observing points to be selected and the point of view from which observation is previously performed is obtained.

αf(|V(P)−V_{c}|)+(1−α)g(Dₘᵢₙ) (6)

In the expression, α is a real number between 0 and 1 representing a balance of weight. The function f( ) is a monotonic increase function while the function g( ) is a monotonic decrease function. That is, in the expression (6), a weighted sum of a value obtained by transforming an absolute value of the difference between the first information quantity and the second information quantity by the function f( ) and a value obtained by transforming Dₘᵢₙ by the function g( ).

In this case, the selecting unit 25 obtains the weighted sum for each of the points of view to be selected by using the expressions (5) and (6), and may select a point of view P with a smaller weighted sum first, or a point of view P with the smallest weighted sum, for example. This allows the user to easily figure out the measurement status of an object to be measured and a point of view in an unobserved direction can be selected first.

Moreover, in the modified example 1 described above, when the relation with a previously selected point of view is taken into account and a point of view in an unobserved direction is to be selected first, the selecting unit 25 may select a point of view by using expressions (7) and (8), for example.

$${D}_{min}^{′} = {\sum }_{i = 1}^{M} {min}_{t = 1 , … , T} ‖ {P}_{i}^{′} - {P}_{t} ‖ \qquad ( 7 )$$

In the expression, D′ₘᵢₙ represents a sum of the smallest values of the distances between the respective points of view P′ᵢ constituting a combination of points of view and the point of view Pₜ from which the observation is previously performed. Note that the point of view Pₜ from which the observation is previously performed may be any point of view included in a combination of points of view from which the observation is previously performed.

αf(|V(P′₁, . . . , P′_{M})−V_{c}|)+(1−α)g(D′ₘᵢₙ) (8)

In the expression (8), a weighted sum of a value obtained by transforming an absolute value of the difference between the first information quantity and the second information quantity by the function f( ) and a value obtained by transforming D′ₘᵢₙ by the function g( ).

In this case, the selecting unit 25 obtains the weighted sum for each combination of points of view by using the expressions (7) and (8), and may select a combination of points of view {P′₁, . . . , P′_{M}} with a smaller weighted sum first, or a combination of points of view {P′₁, . . . , P′_{M}} with the smallest weighted sum, for example. This allows the user to easily figure out the measurement status of an object to be measured and a combination of points of view in an unobserved direction can be selected first.

While a case in which a point of view in an unobserved direction is selected first has been described in the modified example 2 as an example of taking the relation with a point of view from which observation is previously performed into account, a point of view at a certain distance or shorter from a point of view from which observation is previously performed (for example, a point of view from which observation is performed last time) may be selected. In this case, the selecting unit 25 may select a point of view at a certain distance or shorter from the point of view from which observation is performed last time from among the points of view selected by using the expression (3), the expressions (5) and (6), or the expression (7) and (8).

### MODIFIED EXAMPLE 3

While cases in which the first information quantity is a projected area or a value based on a projected area are described in the embodiments and modified examples described above, the first information quantity may be a sum of absolute values of scalar products of normal vectors at respective point data of the three-dimensional shape data (point cloud data) and the line-of-sight direction. As described above, the normal vectors may be included in the three-dimensional shape data or may be calculated from point cloud data.

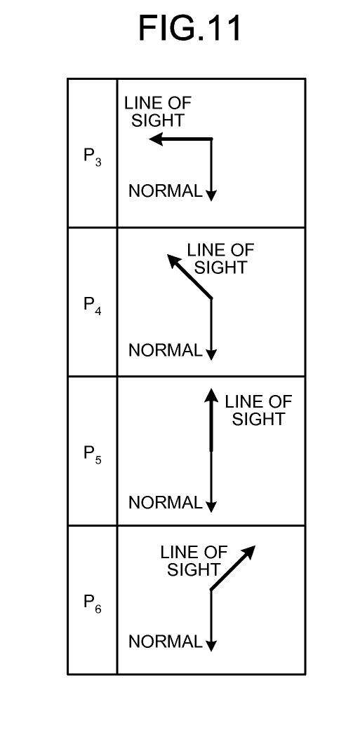

FIG. 11 is an explanatory diagram illustrating an example of the first information quantities according to the modified example 3, and illustrates the scalar products of the normal vectors at respective points of view to be selected P₃ to P₆ and the line-of-sight direction in the example of FIG. 2. Note that in the example illustrated in FIG. 11, scalar products of the normal vectors at point data of the three-dimensional shape data and the line-of-sight direction for respective points of view P₃ to P₆ are illustrated.

### MODIFIED EXAMPLE 4

In the embodiments and the modified examples described above, imaged data obtained by imaging an object and the three-dimensional shape data may be superimposed for display.

In this case, the storage unit 15 stores in advance a plurality of imaged data pieces obtained by imaging the object to be measured. The imaged data pieces are preferably obtained by imaging the object to be measured equally from various angles.

In selecting a point of view, the selecting unit 25 selects the point of view from the points of view to be selected and the points of view from which the imaged data are taken. This can significantly reduce the computation for selecting points of view and make the points of view from which the three-dimensional shape data are viewed and the points of view from which the imaged data are taken correspond to each other, which leads to improvement in the quality of superimposed display.

In addition, the display control unit 27 superimposes the three-dimensional shape data as viewed from the point of view selected by the selecting unit 25 and the imaged data obtained by imaging the object from the point of view selected by the selecting unit 25 and displays the superimposed result on the display unit 13. A technique disclosed in Japanese Patent Application Laid-open No. 2009-075117 may be used as the technique for displaying a superimposed display.

This allows the user to more easily figure out the measurement status of an object to be measured, which can increase the efficiency of the measurement work on the object to be measured.

Hardware Configuration

An example of a hardware configuration of a measurement support device according to the embodiments and modified examples described above will be described. The measurement support device according to the embodiments and modified examples described above includes a control device such as a CPU, a storage device such as a ROM and a RAM, an input device such as a keyboard and a mouse, and a communication device such as a communication interface, which is a hardware configuration utilizing a common computer system.

Programs to be executed by the measurement support device according to the embodiments and modified examples described above may be recorded on a computer readable recording medium such as CD-ROM, a CD-R, a memory card, a digital versatile disk (DVD), and a flexible disk (FD) in a form of a file that can be installed or executed, and provided therefrom.

Alternatively, the programs to be executed by the measurement support device according to the embodiments and modified examples described above may be stored on a computer system connected to a network such as the Internet, and provided by being downloaded via the network. Still alternatively, the programs to be executed by the measurement support device according to the embodiments and modified examples described above may be provided or distributed via a network such as the Internet. Still alternatively, the programs to be executed by the measurement support device according to the embodiments and modified examples described above may be embedded on a ROM or the like in advance and provided therefrom.

The programs to be executed by the measurement support device according to the embodiments and modified examples described above have modular structures including the respective units described above. In an actual hardware configuration, the CPU reads the programs from the HDD and executes the programs, whereby the respective units are implemented on the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the steps in the flowcharts in the embodiments may be changed in the order in which the steps are performed, may be performed simultaneously or may be performed in a different order each time the steps are performed as long as the change is not inconsistent with the nature thereof.

As described above, according to the embodiments and modified examples described above, the work efficiency of measurement can be increased.

What is claimed is:

1. A measurement support device comprising:
a first calculator configured to calculate, when three-dimensional shape data representing a measured part of an object are viewed from a plurality of points of view, a plurality of first information quantities representing visibility of the three-dimensional shape;
a second calculator configured to calculate a second information quantity by multiplying a maximum value of the first information quantities by a predetermined proportion;
a selector configured to select a point of view, which has a smaller difference between the first information quantity and the second information quantity, from the points of view; and
a display controller configured to display the three-dimensional shape data as viewed from the selected point of view on a display unit.

2. The device according to claim 1, wherein the selector selects a point of view with a first information quantity whose difference from the second information quantity is within a predetermined range among the first information quantities.

3. The device according to claim 1, wherein the selector selects a point of view from the points of view further taking a relation with a point of view from which observation is previously performed into account.

4. The device according to claim 1, wherein the first calculator calculates the first information quantity for each of the points of view.

5. The device according to claim 1, wherein
the first calculator calculates, for each combination of points of view, the first information quantity by summing up maximum values of visibility of parts constituting the three-dimensional shape data,
the selector selects a combination of points of view from the points of view by using a difference between each of the first information quantities and the second information quantity, and
the display controller displays the three-dimensional shape data as viewed from the selected combination of points of view on the display unit.

6. The device according to claim 1, wherein the first information quantity is a projected area of the three-dimensional shape data projected on a projection plane in a line-of-sight direction of the point of view or a direction opposite thereto.

7. The device according to claim 1, wherein
the three-dimensional shape data are point cloud data of points constituting a shape of the object, and
the first information quantity is a sum of absolute values of scalar products of normal vectors at the respective points of the three-dimensional shape data and directional vectors in line-of-sight directions.

8. The device according to claim 1, wherein the display controller superimposes the three-dimensional shape data as viewed from the selected point of view and imaged data obtained by imaging the object from the selected point of view and displays the superimposed result on the display unit.

9. The device according to claim 1, wherein the points of view are part of a set of points of view provided as points of view for viewing the three-dimensional shape data.

10. The device according to claims 1, wherein
the three-dimensional shape data are point cloud data of points constituting a shape of the object, and
the first calculator calculates the first information quantity by using part of the point data constituting the three-dimensional shape data.

11. The device according to claim 1, further comprising:
an observing unit configured to observe the object; and
a generating unit configured to generate the three-dimensional shape data by using a result of the observation.

12. A measurement support method comprising:
calculating, when three-dimensional shape data representing a measured part of an object are viewed from a plurality of points of view, a plurality of first information quantities representing visibility of the three-dimensional shape, by a first calculating unit;
calculating a second information quantity by multiplying a maximum value of the first information quantities by a predetermined proportion, by a second calculating unit;
selecting a point of view, which has a smaller difference between the first information quantity and the second information quantity, from the points of view; and
displaying the three-dimensional shape data as viewed from the selected point of view on a display unit, by a display control unit.

13. A computer program product comprising a computer-readable medium including a computer program that causes a computer to execute:
calculating, when three-dimensional shape data representing a measured part of an object are viewed from a plurality of points of view, a plurality of first information quantities representing visibility of the three-dimensional shape;
calculating a second information quantity by multiplying a maximum value of the first information quantities by a predetermined proportion;
selecting a point of view, which has a smaller difference between the first information quantity and the second information quantity, from the points of view; and
displaying the three-dimensional shape data as viewed from the selected point of view on a display unit.
